(19) United States
(12) Patent Application Publication
(10) Pub. No.: US 2017/0170856 A1
(43) Pub. Date: Jun. 15, 2017

(54) CLOUD SIM CARD POOL SYSTEM

(71) Applicant: Shenzhen Dimior Technologies Co., Ltd., Shenzhen (CN)

(72) Inventor: Xiaojun Shen, SHENZHEN (CN)

(21) Appl. No.: 15/407,720

(22) Filed: Jan. 17, 2017

Related U.S. Application Data
(63) Continuation of application No. PCT/CN2016/108995, filed on Dec. 8, 2016.

(30) Foreign Application Priority Data
Dec. 10, 2015 (CN) 201510910144.5

(51) Int. Cl. H04B 1/3816; H04W 8/18; H04L 29/08

(52) U.S. Cl. CPC H04B 1/3816; H04L 67/1097; H04W 8/18

(57) ABSTRACT

A cloud SIM (Subscriber Identity Module) card pool system includes at least one SIM card pool device having multiple card slots for storing different physical SIM cards, an SIM card pool management center, and at least one terminal communication device. The SIM card pool management center selects optical communication paths to distribute SIM card data corresponding to the physical SIM cards to terminal communication device according to a distribution strategy and the state of the terminal communication device, and distributes multiple optimal communication paths when the terminal communication device are communicated with the SIM card pool device. The terminal communication device reports the current state to the SIM card pool management center, obtains the best matched SIM card data distributed by the SIM card pool management center, visits an authentication algorithm of a corresponding physical SIM card through the optimal communication paths, and obtains the corresponding answer data.

### CROSS-REFERENCE TO RELATED APPLICATIONS

This application is a continuation of International Patent Application No. PCT/CN2016/108995, with an international filing date of Dec. 8, 2016, designating the United States, now pending, which is based on Chinese Patent Application No. 201510910144.5, filed Dec. 10, 2015. The entire contents of these specifications are incorporated herein by reference.

### TECHNICAL FIELD

The present invention relates to an elastic cloud and SIM card virtualization technology, and rapidly and economically offers SIM card data access services for mobile terminal devices throughout the world.

### BACKGROUND ART

In the field of mobile terminal device, an SIM card is a very important SIM (Subscriber Identity Module), mainly containing an IMSI (International Mobile Subscriber Identification Number), a KI value and encryption algorithms and operator information, etc. The SIM card is offered by the operator to a subscriber, the subscriber inserts the effective SIM card into the mobile terminal device, then the terminal device can be recognized and authenticated through the subscriber identity of the operator network; otherwise, fails to be registered and use the network. In recent years, with the rapid development of Mobile Internet, the variety of the mobile terminal device also is increasingly rich, a large number of SIM cards are applied to various types of terminal devices; moreover, the mobile terminal device is endowed with roaming characteristics, and its working position moves everywhere. If one mobile terminal device fixedly uses one SIM card, then a lot of problems are easily caused, for example, the network of certain operators in some places has a weaker signal or no signal completely, which will affect the subscriber to use; for another example, the subscriber often needs to pay high roaming fee during the international roaming; for another example, extra fee needs to be paid if items of the package purchased by the operator are used too much, or waste is caused as some items cannot be used up, etc.

In order to solve these problems, a multi-SIM card solution is introduced in the industry, for example, a mobile terminal having a plurality of SIM card slots is used, and a certain SIM card is selected through a built-in management strategy. Such method needs to reserve a plurality of SIM card slots, which not only limits the number, but also fixedly occupies a plurality of SIM cards. In this way, the cost is increased, but the convenience may not be increased in proportion. For another example, the enhanced SIM card is used, a plurality of cards are integrated in one, one physical SIM card is written with the SIM card data of the plurality of operators at the same time, and the certain SIM card data is selected by the mobile terminal device via the built-in management strategy. Through this method, the mobile terminal device only needs one SIM card slot, but the physical SIM cards requires an enough large storage capacity, and how to write the SIM card data of the plurality of operators relates to card issuing/manufacturing links of the operators, which is inconvenient for coordination. Another solution is to use a virtual SIM card, to digitalize the core subscriber data of the plurality of SIM cards and encryption algorithm, to completely cancel the physical SIM card, directly write a plurality of data in a special storage area of the mobile terminal equipment, and to select the data of the certain virtual SIM card by the mobile terminal device via the built-in management strategy. Through this method, the virtual SIM card is used, and the operators are required to completely open the core subscriber data of the SIM card and the encryption algorithm, which will bring serious potential security hazards and affect the interests of operators. Therefore, it is often rejected by the operators, and has very high difficulty.

### SUMMARY OF THE INVENTION

In order to solve the above problem of the prior art, the present invention proposes a cloud SIM card pool system, comprising:

at least one SIM card pool device, provided with a plurality of card slots for storing different physical SIM cards;

an SIM card pool management center, comprising a cloud server cluster, an SIM card pool database arranged in the cloud server cluster for storing the SIM card data, and a cloud forwarding node; the SIM card pool management center selecting a cloud forwarding node closest to the terminal communication device to distribute corresponding SIM card data to terminal communication device according to a distribution strategy and the state of the terminal communication device; and

at least one terminal communication device, reporting the current state to the SIM card pool management center, receiving the corresponding SIM card data distributed by the SIM card pool management center, and being communicated with the corresponding SIM card pool device through the cloud forwarding node, utilizing an authentication algorithm of a physical SIM card to obtain a corresponding answer data, thereby simulating an operation environment of the physical SIM cards, and enabling the SIM card data to be converted into virtual SIM cards for use.

The present invention does not need to install a real SIM card in the mobile terminal device, stores the SIM card of different operators and different packages in the SIM card pool device, and then uses the SIM card pool management center to distribute and manage the SIM card data, and controls the communication between the mobile terminal communication device and the physical SIM card in the SIM card pool device only when the authentication algorithm is needed to realize the dynamic binding between the physical SIM card and the mobile terminal device, thus achieving the object of global flexible card exchange. The corresponding SIM card in the card pool is used in an appropriate place and an appropriate time via a flexible charging strategy, so that the SIM card can be safely managed in a centralized manner. In this way, it is not necessary to exchange the card in a remote manner while significantly reducing the communication charge of regional roaming and international roaming, so as to reduce the cost of maintenance of card exchange.

### BRIEF DESCRIPTION OF THE DRAWINGS

FIG. 1 is a structural schematic diagram of the present invention;

FIG. 2 is a structural schematic diagram of a cloud server cluster of the present invention;

FIG. 3 is an interaction flow diagram of the cloud server cluster and terminal communication device of the present invention; and

FIG. 4 is a schematic diagram of the terminal communication device simulating a SIM card to work.

### DETAILED DESCRIPTION OF THE PREFERRED EMBODIMENTS

The principle and the working process of the present invention is described in details with reference to the drawings hereinafter.

As shown in FIG. 1, a cloud SIM card pool system of the present invention, based on Cloud Computing, mainly relates to three portions, including a SIM card pool device, a terminal communication device and an SIM card pool management center respectively.

The SIM card pool device is provided with a plurality of card slots for storing physical SIM cards in a centralized manner, and a plurality of SIM card pool device can be provided according to the needs. The country, the network operator, the charging package adopted, and the applicable network system of the physical SIM card in the SIM card pool device can be different from each other.

The terminal communication device can be any device in the world capable of using the SIM card, such as mobile phone, tablet computer, or the like.

The SIM card pool management center comprises a cloud server cluster and a distributed cloud forwarding node, and can dynamically distribute the SIM card data of the physical SIM card in the SIM card pool device for the terminal communication device to use.

The cloud forwarding node refers to a plurality of intelligent routers distributed based on an elastic cloud technology, which can provide a high-speed and reliable data forwarding route, and can effectively cover throughout the key areas in the world.

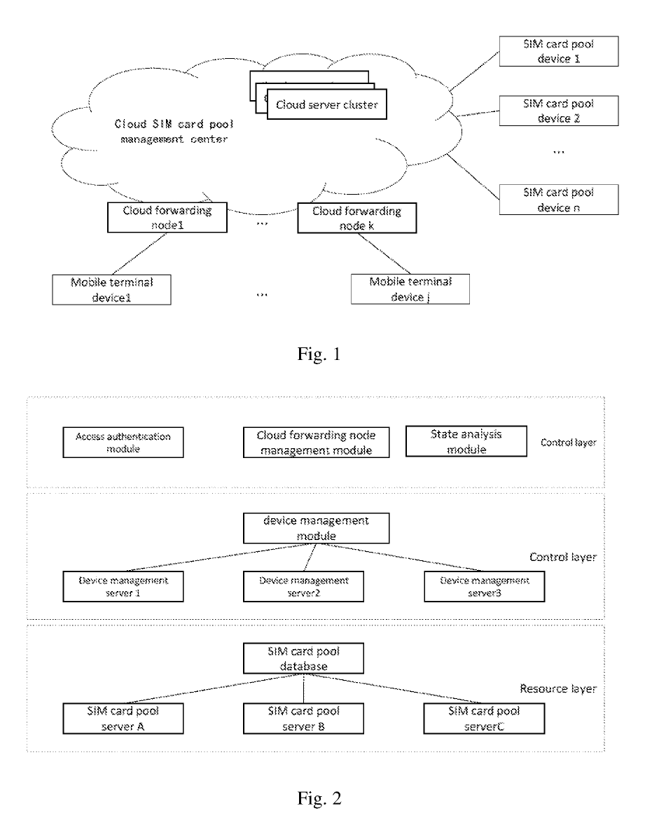

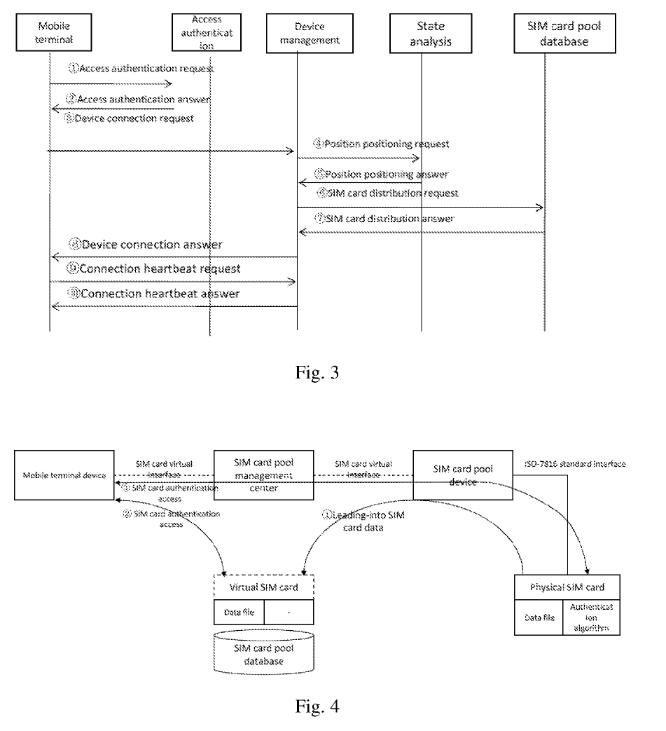

As shown in FIG. 2 and FIG. 3, the cloud server cluster comprises an SIM card pool database, an access authentication module, a cloud forwarding node management module, and a state analysis module and a device management module of the terminal communication device, these modules and databases are formed by a plurality of physical servers and corresponding management software, belonging to a control layer, a device layer and a resource layer respectively.

The access authentication module verifies whether the mobile terminal communication device is legitimate according to a unique identifier and an authentication password of the mobile terminal communication device, the mobile terminal communication device is allowed to access to the SIM card management center only if passing though the verification. The mobile terminal device initiates an access authentication request carrying the unique identification of the device, the access authentication module identifies the identity and the access right of the mobile terminal device, performs the authentication processing, and if the authentication processing passes, the access authentication module returns an authentication result to the mobile terminal device and carries device management server identification and other information.

The cloud forwarding node management module is used for managing the cloud forwarding node, and intelligently selecting the fastest/closest communication path when the terminal communication device is communicated with the SIM pool management center. When the terminal communication device is communicated with the SIM card pool device, the cloud forwarding node management module can select a plurality of preferred paths, and forward the involved encrypted data/time-limited data in a redundancy manner according to the fastest/closest priority sequence because of the involved encrypted data/time-limited data, which cannot only improve the transmission speed, but also can effectively avoid the packet loss by taking the earliest received data as the criterion.

The state analysis module of the terminal communication device is periodically communicated with the terminal communication device and receives the current state periodically reported by the terminal communication device. The current state can be the current position information, or the network signal or a combination thereof. The state analysis module of the terminal communication device analyzes the current state of the terminal communication device after receiving the current state reported by the terminal communication device to obtain the current geographical position of the terminal communication device and/or the operator of the corresponding strongest network signal, and then distribute the most suitable SIM card data in the SIM card pool for the terminal communication device according to the distribution strategy.

The device management module is used for managing a large number of mobile terminal devices and handling the access request of the mobile terminal device. The device management module can include a plurality of device management servers. Each device management server adopts a load sharing mode to manage the mobile terminal device with a certain capacity, for example, one virtual machine manages at most 10,000 mobile terminal devices. When the SIM card is not used in the terminal communication device, the mobile terminal communication device initiates a connection request to the device management server, carrying the device position, the strength of the mobile network signal and other information. The device management server initiates a positioning request to the state of the terminal communication device, and the analysis module of the terminal communication device analyzes the current state (position and/or network signal) of the terminal communication device and analyzes the detailed physical position information, including country and province, region/city, street, and other information. And then a distribution request of the SIM card data is initiated to the SIM card pool database. The SIM card pool database finds out the best matched SIM card data with the current state of the terminal communication device in combination with the distribution strategy of the

SIM card, dynamically distributes one SIM card, and returns an answer. The device management server returns a connection answer to the mobile terminal communication device, carrying the SIM card data obtained by distribution.

Thereafter, the mobile terminal communication device performs a heartbeat request, and periodically reports the position information, the strength of the mobile network signal strength and the connection information to the device management module. The device management module returns a heartbeat answer according to the working condition of the mobile terminal communication device, carrying maintenance connection or card changing indication and other control information.

The SIM card pool database is used for storing the SIM card data of all physical SIM cards in the SIM card pool device, and the SIM data refer to the unencrypted SIM card data copied according to a Host role of the ISO7816 standard. The SIM card pool database contains a plurality SIM card pools, the SIM card data are classified according to the attribute of the SIM card, the same type of SIM card data is put in the same SIM card pool, so we can define at least one classification attribute for the SIM card pool. In order to facilitate understanding, we can compare a SIM card pool image to a folder. The invention mainly uses the classification attribute of the IMSI and the SIM card pool to classify the SIM card data, defines the management identification of the SIM card pool and realizes the automatic classification, so as to avoid various possible errors caused by the manual management.

IMSI (International Mobile Subscriber Identification Number) refers to an international mobile subscriber identification number, which is stored in the SIM card for identifying and distinguishing mobile subscribers, has a total length of not more than 15 bits, uses the numbers 0 to 9 in the similar way. A coded format of the IMSI can refer to the appendix at the end of this description.

The management identification of the SIM card pool is used for distinguishing a particular type of SIM card, for example, can be defined in a rule: {card pool level, mobile country code, mobile network code, business classification code}.

When the SIM card data are automatically classified, the IMSI identification (identifying the {country code} and the {mobile network code}) of the SIM card and the SIM card pool (setting the classification attribute {card pool level} and {business classification}) can be utilized, for example, two examples in the following table can be stored in two different SIM card pools respectively:

| | Example 1 | Example 2 |
|---|---|---|
| Definition of SIM card | L1-46000-GD | L1-46001-GD |
| pool identification | | |
| Card pool level | L1-ordinary card pool | L1-ordinary card pool |
| Mobile country code | 460-China | 460-China |
| Mobile network code | 00-China Mobile | 01-China Unicom |
| Business classification | GD-self-defined | GD-self-defined |
| | Guangdong data card | Guangdong data card |

After pre-setting the {card pool level-L1} and the {business classification-GD} in the SIM card pool, it is automatically classified into the SIM card pool identified as L1-46000-GD as long as the SIM card of Guangdong Mobile is inserted; while it is automatically classified into the SIM card pool identified as L1-46001-GD as long as the SIM card of Guangdong Unicom is inserted.

The SIM card data in each SIM card pool have the corresponding business attributes, including roaming service area, domestic service area, attribution information, charging strategy, Internet configuration, and network system, etc. Among them, the roaming service area contains a list of roaming countries, and the charging strategy contains a charging package limit, a charging rate, a working time and other contents corresponding to the SIM card.

The SIM card pool management center with respect to the geographical position of the terminal communication device can resolve the corresponding position information, obtain the {country code, province code, regional/city code}, and then obtain a dynamic strategy routing table: {country code, province code, region/city code, management identification of SIM card pool, charging strategy, network performance, scheduling priority} according to the roaming service area, the domestic service area and other business attributes of the SIM card pool. We can divide the data of a strategy routing table into three types, including static priority, rate priority, and performance priority respectively. The SIM card pool management center can choose different priority strategies as the distribution strategy according to different business needs. The static priority is to screen and sort according to the corresponding conditions appointed artificially to obtain a series of available SIM card data list according to the level of matching degree; the rate priority is to sort according to the charging rate of the SIM card pool to obtain a series of available SIM Card data list, with low cost and high priority; the performance priority is to sort according to the network performance data of the SIM card pool to obtain a series of available SIM card data, with high performance and high priority.

As shown in FIG. 4, the terminal communication device reports the state thereof to the SIM pool management center, for example, informing the SIM card management center that the terminal communication device is idle and needs to distribute a suitable SIM card, or informing the SIM card pool management center of the current position information, base station information and the like, and of needing the SIM card pool management center to re-distribute the most suitable SIM card. The SIM card pool management center distributes the most suitable SIM card data to the terminal communication device according to the current state of the terminal communication device. Then, the terminal communication device converts the received SIM card data into a virtual SIM card so as to realize the service request of the terminal communication device. The mobile communication module of the present invention can support any one system of GSM, 3G and 4G.

In the process of the mobile communication module accessing to the virtual SIM card, because the virtual SIM card only has the static data, that is only having part of the non-encrypted data, certain messages, such as authentication messages, timeliness messages or encrypted messages, need to be generated by means of the authentication algorithm of the physical SIM card. At this moment, the mobile terminal communication device forwards the request data after coding compression to the SIM card pool device through the cloud forwarding node path distributed by the SIM card pool management center, the physical SIM card in the SIM card pool device answers, then, the answer data of the physical SIM card after coding compression is forwarded to the terminal communication device, so as to realize the answer to the request. In the forwarding process of the request data (timeliness message or encrypted message) and the answer data thereof, the SIM card pool management center will select a plurality of preferred paths, a sender forwards the timeliness message through a plurality of paths at the same time, a receiver receives the message with the lowest an fastest information packet loss rate, to ensure a sending speed and sending quality in quantity.

### Appendix:

1. A coded format of the IMSI is MCC+MNC+MSIN, which is described as follows:

MCC (Mobile Country Code) refers to a mobile country code. The resources of the MCC are uniformly distributed and managed by the International Telecommunication Union (ITU) across the world, and used for uniquely identifying the country of the mobile subscriber, totaling 3 bits, wherein China is 460.

MNC (Mobile Network Code) refers to a mobile network code, used for identifying the mobile communication network of the mobile subscriber affiliated to, 2-3 bits. In the same country, if there is a plurality of PLMNs (Public Land Mobile Network, one operator in a country generally corresponds to one PLMN), the PLMNs can be distinguished by the MNC, that is, each PLMN should be distributed with the unique MNC. China Mobile system uses 00, 02, and 07, China Unicom GSM system uses 01 and 06, China Telecom CDMA system uses 03 and05, Telecom 4G uses 11, and China Railcom system uses 20.

MSIN (Mobile Subscriber Identification Number) refers to a mobile subscriber identification number, used for identifying the mobile subscriber in the certain mobile communication network, totaling 10 bits.

2. ICCID (Integrate Circuit Card Identity) of the SIM card refers to an integrate circuit card identification code), fixed in the SIM card of the mobile phone. The ICCID is a unique identification number of the IC card, totaling 20 numbers, with the general coded format as: XXXXXX OMFSS YYGXX XXXXX.The first six-bit is the operator ID code, China Mobile: 898600 and 898602; China Unicom: 898601; China Telecom: 898603.

However, different operators have different specific coded formats of the ICCID, for example:

Coded format of China Mobile: 898600MFSSYYGXXXXXXP

Coded format of China Unicom: 898601YY8SSXXXXXXXXP

Coded format of China Telecom: 898603MYYHHHXXXXXXXP

It should be noted that the more detailed description is made for specific embodiments above, but it cannot be therefore deemed as the limitation to the patent protection scope of the present invention, and the patent protection scope of the present invention shall be subject to the claims attached.

What is claimed is:

1. A cloud SIM (Subscriber Identity Module) card pool system, comprising:
at least one SIM card pool device, provided with a plurality of card slots for storing different physical SIM cards;
an SIM card pool management center, selecting optical communication paths to distribute SIM card data corresponding to the physical SIM cards to terminal communication device according to a distribution strategy and the state of the terminal communication device, and distributes a plurality of optimal communication paths when the terminal communication device being communicated with the SIM card pool device; and
at least one piece of terminal communication device, reporting the current state to the SIM card pool management center, obtaining the SIM card data of the best matched physical SIM card with the current state distributed by the SIM card pool management center, visiting an authentication algorithm of a corresponding physical SIM card through the plurality of optimal communication paths, obtaining the corresponding answer data, thereby simulating an operation environment of the physical SIM cards, and enabling the SIM card data to be converted into virtual SIM cards for use.

2. The system according to claim 1, wherein the SIM card pool management center comprises a cloud server cluster and a distributed cloud forwarding node.

3. The system according to claim 2, wherein the cloud server cluster comprises:
a device management module, configured to receive an access request of the terminal communication device, and return the answer data to the terminal communication device;
a state analysis module of the terminal communication device, configured to analyze the current state of the terminal communication device, then transmit to the SIM card pool database, and ask for distributing the corresponding SIM card data;
an SIM card pool database, configured to store the SIM card data corresponding to the physical SIM card, find out the best matched SIM card data with the current state of the terminal communication device according to the received distribution request and in combination with the distribution strategy, and return the SIM card data to the device management module; and
a cloud forwarding node management module, configured to manage the distributed cloud forwarding node, and provide at least one closest/fastest communication path constituted by the cloud forwarding node according to the state of the terminal communication device.

4. The system according to claim 3, wherein the SIM card data is classified by the SIM card pool database, and the same type of SIM card data are classified into an SIM card pool.

5. The system according to claim 3, wherein the cloud server cluster further comprises an access authentication module, used for verifying whether the terminal communication device is legitimate, if yes, then the terminal communication device is allowed to access to the cloud server cluster.

6. The system according to any one of claim 1, wherein the plurality of optimal communication paths are distributed by the SIM card pool management center according to a closest distance and/or a fastest speed in sequence.

7. The system according to any one of claim 1, wherein the state of the terminal communication device comprises one or combination of position information and network signal.

8. The system according to any one of claim 1, wherein the distribution strategy comprises a static priority distribution strategy screened by an artificially appointed condition, a tariff priority distribution strategy screened according to the tariff, and a performance priority distribution strategy screened according to the network performance of the SIM card.
